(19) United States
(12) Patent Application Publication
(10) Pub. No.: US 2020/0079219 A1
(43) Pub. Date: Mar. 12, 2020

(54) Hybrid Vehicle Brake Control

(71) Applicant: Ford Global Technologies, LLC, Dearborn, MI (US)

(72) Inventors: Shunsuke Okubo, Belleville, MI (US); Dale Scott Crombez, Livonia, MI (US)

(21) Appl. No.: 16/128,820

(22) Filed: Sep. 12, 2018

(51) Int. Cl. B60L 7/26; B60L 7/18; B60T 8/17

(52) U.S. Cl. CPC B60L 7/26; B60L 7/18; B60L 2240/12; B60T 2250/04; B60T 8/17

(57) ABSTRACT

In a hybrid vehicle, brake force is divided between friction brakes and regenerative braking. When the friction brakes are wet, the delivered braking force may exceed the commanded braking force resulting in a poor transition from regenerative braking to friction braking. When wet friction brakes are detected, a controller allocates more of the total braking energy to friction brakes until a threshold quantity of energy has been dissipated in the friction brakes, thus drying the friction brakes over fewer braking events than otherwise.

### TECHNICAL FIELD

This disclosure relates to the field of hybrid vehicles. More particularly, the disclosure pertains to a control system for allocating braking force between friction brakes and regenerative brakes.

### BACKGROUND

Many vehicles are used over a wide range of vehicle speeds, including both forward and reverse movement. Internal combustion engines, however, are capable of operating efficiently only within a narrow range of speeds. Consequently, transmissions capable of efficiently transmitting power at a variety of speed ratios are frequently employed. When the vehicle is at low speed, the transmission is usually operated at a high speed ratio such that it multiplies the engine torque for improved acceleration. At high vehicle speed, operating the transmission at a low speed ratio permits an engine speed associated with quiet, fuel efficient cruising.

Hybrid vehicle transmissions improve fuel economy by providing energy storage. In a hybrid electric vehicle, for example, energy may be stored in a battery. The battery may be charged by operating the engine to produce more power than instantaneously required for propulsion. Additionally, energy that would otherwise be dissipated during braking can be captured and stored in the battery. The stored energy may be used later, allowing the engine to produce less power than instantaneously required for propulsion and thereby consuming less fuel.

### SUMMARY OF THE DISCLOSURE

A hybrid vehicle includes friction brakes, an electric motor, and a controller. The friction brakes have brake pads. The electric motor is configured to provide regenerative braking. The controller is programmed to allocate a total braking request between the friction brakes and the motor, and to increase a fraction of braking provided by the friction brakes in response to moisture on the brake pads. The controller may be further programmed to resume an original allocation between the friction brakes and the motor in response to dissipation of a predetermined quantity of heat in the friction brakes after detecting the moisture on the brake pads. The total braking request may be allocated to the friction brakes in response to a vehicle speed being less than a first threshold. The first threshold may be increased in response to the moisture on the brake pads. A maximum fraction of the total braking request may be allocated to regenerative braking in response to the vehicle speed being greater than a second threshold. A difference between the first threshold and the second threshold may be increased in response to the moisture on the brake pads. The maximum fraction may be decreased in response to the moisture on the brake pads.

A hybrid vehicle includes friction brakes having brake pads, an electric motor, and a controller. The electric motor is configured to provide regenerative braking. The controller is programmed to, in response to detection of the brake pads being wet, alter application of the friction brakes such that a greater fraction of braking is performed by the friction brakes than in absence of the detection. The controller may be further programmed to, in response to dissipation of a predetermined quantity of heat in the friction brakes after the detection, further alter application of the friction brakes such that a lesser fraction of braking is performed by the friction brakes than during presence of the detection prior to the dissipation. A total braking request may be allocated to the friction brakes in response to a vehicle speed being less than a first threshold. The first threshold may be increased in response to the brake pads being wet. A maximum fraction of a total braking request may be allocated to regenerative braking in response to a vehicle speed being greater than a second threshold. A difference between the first threshold and the second threshold may be increased in response to the detection. The maximum fraction may be decreased in response to the detection.

A method of controlling a hybrid vehicle having friction brakes and regenerative braking capability acts over several deceleration events from a vehicle speed to stationary at a braking request level. During a first deceleration event, a first fraction of a total braking energy is allocated to the friction brakes. During a second deceleration event, in response to detection of the friction brakes being wet, a second fraction of the total braking energy, greater than the first fraction, is allocated to the friction brakes. During a third deceleration event, in response to dissipation of a predetermined quantity of heat in the friction brakes after the detection, the first fraction of the total braking energy is again allocated to the friction brakes.

### BRIEF DESCRIPTION OF THE DRAWINGS

FIG. 1 is a schematic diagram of a hybrid electric powertrain.

FIG. 2 is a schematic diagram of a braking system.

FIG. 3 is a schematic diagram of a control system for the powertrain of FIG. 1 and the braking system of FIG. 2.

FIG. 4 is a graph illustrating potential allocation of braking force.

FIG. 5 is a flow chart for allocating braking force in the hybrid vehicle of FIGS. 1, 2, and 3.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A group of rotating elements are fixedly coupled to one another if they are constrained to have the same rotational speed about the same axis in all operating conditions. Rotating elements can be fixedly coupled by, for example, spline connections, welding, press fitting, or machining from a common solid. Slight variations in rotational displacement between fixedly coupled elements can occur such as displacement due to lash or shaft compliance. In contrast, two rotating elements are selectively coupled by a shift element when the shift element constrains them to have the same rotational speed about the same axis whenever the shift element is fully engaged and the elements are free to have distinct speeds in at least some other operating condition. Two rotating elements are coupled if they are either fixedly coupled or selectively coupled. Two rotating elements are driveably connected if a series of gears and shafts is capable of transmitting power from one to the other and establishes a fixed speed ratio between the two elements.

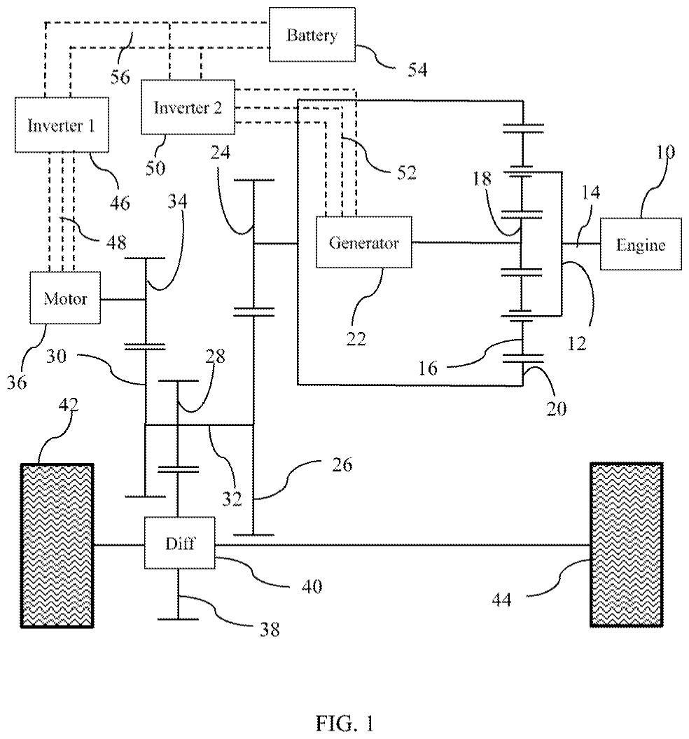

FIG. 1 schematically illustrates a kinematic arrangement for a power-split type hybrid electric vehicle. Power is provided by engine 10 which is fixedly coupled to planet carrier 12 via transmission input shaft 14. A set of planet gears 16 are supported for rotation with respect to carrier 12. Sun gear 18 and ring gear 20 are each supported for rotation about the same axis as carrier 12 and each mesh with the planet gears 16. Generator 22 is fixedly coupled to sun gear 18. Layshaft gear 24 is fixedly coupled to ring gear 20 and meshes with layshaft gear 26. Layshaft gear 26 is fixedly coupled to layshaft gears 28 and 30 via shaft 32. Layshaft gear 34 meshes with layshaft gear 30 and is fixedly couple to motor 36. Layshaft gear 28 meshes with layshaft gear 38 which is the input to differential 40. Differential 40 drives wheels 42 and 44 allowing slight speed differences as the vehicle turns a corner.

Generator 22 and motor 36 are both reversible electric machines. Both machines are capable of converting electrical power to mechanical power or converting mechanical power to electrical power. In this example, each machine is a synchronous Alternating Current (AC) motor. Motor 36 is powered by inverter 46 via three phase AC power connection 48. Similarly, generator 22 is powered by inverter 50 via three phase AC power connection 52. Both inverters are electrically connected to battery 54 via Direct Current bus 56.

In some circumstances, engine 10 may generate more power than is delivered to the vehicle wheels 42 and 44 with the excess power stored in battery 54. In other circumstances, power may flow from battery 54 permitting engine 10 to produce less power than the instantaneous demand of the vehicle. For example, the engine 10 may be off while power to propel the vehicles comes from battery 54. During braking maneuvers, motor 36 may exert negative torque, thus producing electrical energy that is stored in battery 54 to reduce future use of engine 10. Use of motor 36 to provide braking in this manner is called regenerative braking.

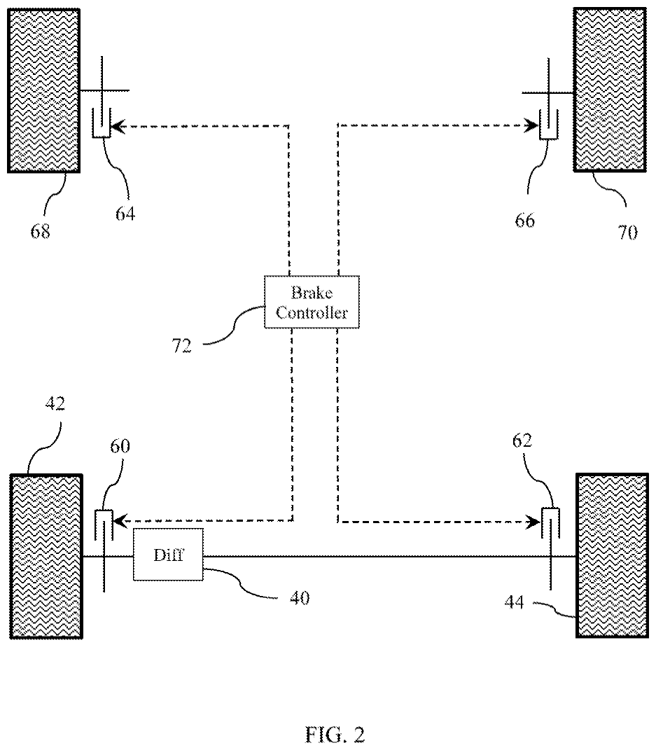

FIG. 2 schematically illustrates a friction braking system. Friction brakes 60 and 62 apply torque against the direction of rotation of front wheels 42 and 44 respectively. Similarly, friction brakes 64 and 66 apply torque against the direction of rotation of rear wheels 68 and 70 respectively. Brake controller 72 sends signals each brake to set the amount of braking. These signals may be, for example, hydraulic pressures in brake lines. In some embodiments, controller 72 may be configured to set the control each of the four brakes independently. In other embodiments, the same signal may be sent to all four brakes.

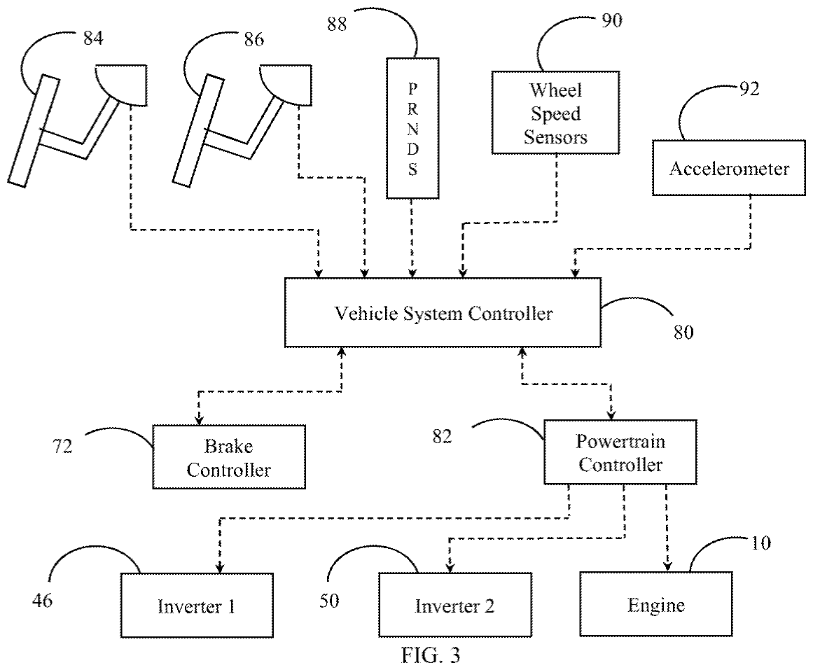

FIG. 3 schematically illustrates a control system designed to control the powertrain of FIG. 1 and the braking system of FIG. 2. Vehicle system controller 80 determines the wheel torque desired and sends signals to brake controller 72 and powertrain controller 82 indicating the wheel torque that each should deliver. The vehicle driver indicates the wheel torque desired via accelerator pedal 84, brake pedal 86, and mode selector 88. Vehicle system controller 80 may also utilize information from other sensors such as wheel speed sensors 90 and an accelerometer 92. Powertrain controller 82 adjust the wheel torque (positive or negative) delivered by the powertrain by sending commands to engine 10 and inverters 46 and 50, indicating what torque the engine and electric machines should produce. Controllers 72, 80, and 82 may be integrated into a single processor or may be implemented as multiple communicating processors.

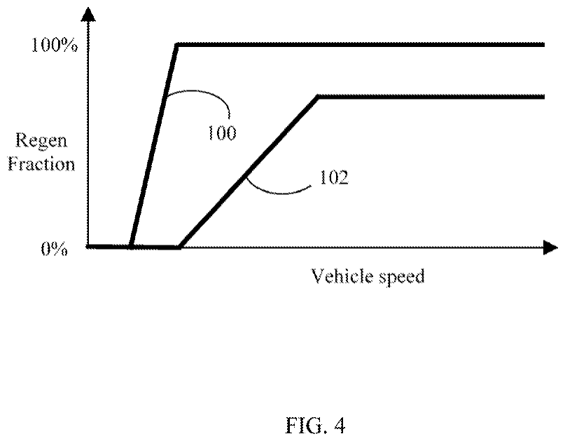

Referring to FIG. 4, line 100 illustrates a function that normally governs the allocation of brake torque between friction braking and regenerative braking. Below a speed of about 5 mph, all braking is allocated to the friction brakes. In other words, the regenerative fraction is 0%. Above a speed of about 10 mph, all braking is allocated to regenerative braking, subject to constraints on motor and battery capability. In other words, unless limited by motor or battery capability, the regenerative fraction is 100%. Between these speeds, the regenerative fraction varies linearly with vehicle speed. As such, as a vehicle slows down, there is a gradual transition from all regenerative braking to all friction braking. Ideally, the friction braking force remains constant through this transition when the brake pedal is held in a steady position. However, it can be difficult to control this transition when the brake pads are wet because the coefficient of friction may be elevated compared with dry brakes. To alleviate this issue, a different function may be used when wet brake pads are detected, such as the function illustrated at 102 in FIG. 4. Utilizing this alternate function improves the transition for several reasons. First, the transition occurs more gradually. Second, more energy is dissipated in the friction brakes during each braking event, causing more rapid evaporation of the moisture.

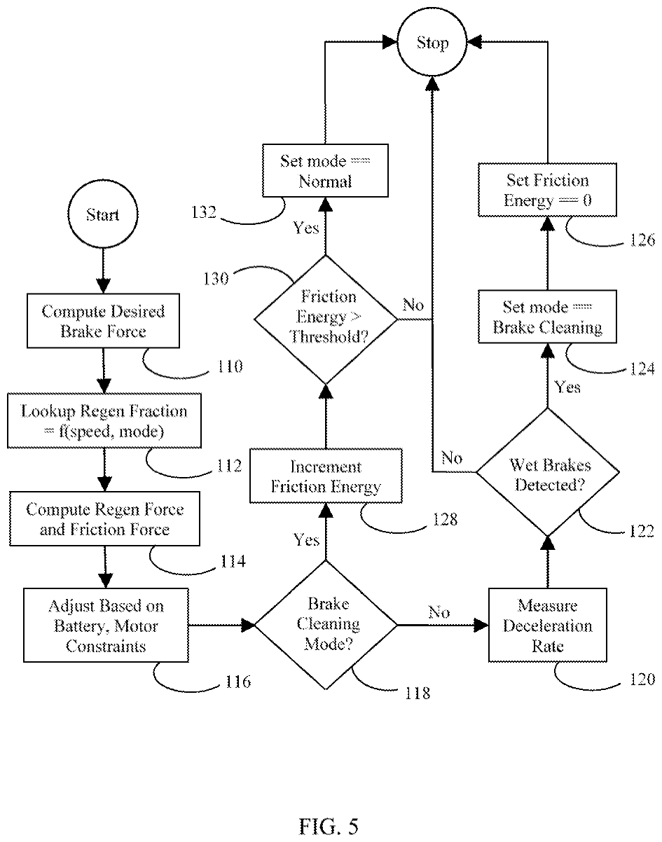

FIG. 5 illustrates a method for allocating the braking force between friction braking and regenerative braking. This process executed by the vehicles systems controller at regular intervals, such as every 10 ms, whenever braking is requested (brake pedal depressed and/or accelerator pedal released). The method recognizes two different operating modes: Normal and Brake Cleaning. The mode is initially set to Normal. The mode is retained between executions of the method. The process begins at 110 by computing the desired braking force. The braking force is predominantly a function of the degree of depression (or pressure) of brake pedal 86. It may also be a function of vehicle speed or other parameters. The desired brake force may be set to a relatively small value when both accelerator pedal 84 and brake pedal 86 are released. At 112, the controller looks up the regenerative braking fraction using function 100 or 102, whichever corresponds to the presently active mode. At 114, the controller computes the desired regenerative braking force by multiplying the desired total braking force by the regenerative fraction and computes the desired friction braking force by allocating the remainder to friction braking. At 116, these values are adjusted if necessary based on motor and battery constraints, keeping the total constant.

The method branches at 118 based on which mode is active. If the Normal mode is active, the method proceeds to 120 at which the deceleration rate is measured. This may be accomplished with an accelerometer or by numerically differentiating vehicle speed. At 122, the controller utilizes the measured deceleration rate to detect whether the brake pads are wet. If the measured deceleration rate increases markedly when transitioning from regenerative braking to friction braking at a constant total desired braking force, then the controller concludes that the brakes are wet. If the brakes are not wet, the method ends without transitioning from Normal mode. If the brakes are wet, the method transitions to Brake cleaning mode at 124 and initializes a parameter called Friction Energy at 126. Use of the Friction Energy parameter is described below.

If the Brake Cleaning mode is active at 118, the method proceeds to 128 at which the Friction Energy parameter is incremented by the amount of energy dissipated in the friction brakes since the last execution. The incremental energy dissipated is proportional to the desired friction braking force multiplied by vehicle speed. At 130, the Friction Energy is compared to a predetermined threshold. This threshold is selected to represent an amount of energy that is generally sufficient to evaporate moisture from the brake pads. If Friction Energy is less than the threshold, then the method exits without changing modes. If the Friction Energy exceeds the threshold, the method transitions to Normal mode at 132 before exiting.

With this method in place, wet brake pads are detected on the first braking event. In subsequent braking events, the friction brakes will be utilized to a larger extent than normal, leading to more rapid evaporation. During the brake cleaning process, the friction brakes may be utilized to some extent at all vehicle speeds even when the battery and motor are capable of additional regenerative braking. Furthermore, the controller may transition to entirely friction brakes at a higher speed than during the normal mode. The brake cleaning process is terminated based on the energy dissipated in the friction brakes.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A hybrid vehicle comprising:
friction brakes having brake pads;
an electric motor configured to provide regenerative braking; and
a controller programmed to
allocate a total braking request between the friction brakes and the motor, and
increase a fraction of braking provided by the friction brakes in response to moisture on the brake pads.

2. The hybrid vehicle of claim 1 wherein the controller is further programmed to resume an original allocation between the friction brakes and the motor in response to dissipation of a predetermined quantity of heat in the friction brakes after detecting the moisture on the brake pads.

3. The hybrid vehicle of claim 1 wherein:
the total braking request is allocated to the friction brakes in response to a vehicle speed being less than a first threshold; and
the first threshold is increased in response to the moisture on the brake pads.

4. The hybrid vehicle of claim 3 wherein:
a maximum fraction of the total braking request is allocated to regenerative braking in response to the vehicle speed being greater than a second threshold; and
a difference between the first threshold and the second threshold is increased in response to the moisture on the brake pads.

5. The hybrid vehicle of claim 1 wherein:
a maximum fraction of the total braking request is allocated to regenerative braking in response to a vehicle speed being greater than a second threshold; and
the maximum fraction is decreased in response to the moisture on the brake pads.

6. The hybrid vehicle of claim 5 wherein the maximum fraction is 100 percent.

7. A hybrid vehicle comprising:
friction brakes having brake pads;
an electric motor configured to provide regenerative braking; and
a controller programmed to, in response to detection of the brake pads being wet, alter application of the friction brakes such that a greater fraction of braking is performed by the friction brakes than in absence of the detection.

8. The hybrid vehicle of claim 7 wherein the controller is further programmed to, in response to dissipation of a predetermined quantity of heat in the friction brakes after the detection, further alter application of the friction brakes such that a lesser fraction of braking is performed by the friction brakes than during presence of the detection prior to the dissipation.

9. The hybrid vehicle of claim 7 wherein:
a total braking request is allocated to the friction brakes in response to a vehicle speed being less than a first threshold; and
the first threshold is increased in response to the brake pads being wet.

10. The hybrid vehicle of claim 9 wherein:
a maximum fraction of the total braking request is allocated to regenerative braking in response to the vehicle speed being greater than a second threshold; and
a difference between the first threshold and the second threshold is increased in response to the detection.

11. The hybrid vehicle of claim 7 wherein:
a maximum fraction of a total braking request is allocated to regenerative braking in response to a vehicle speed being greater than a second threshold; and
the maximum fraction is decreased in response to the detection.

12. The hybrid vehicle of claim 11 wherein the maximum fraction is 100 percent.

13. A method of controlling a hybrid vehicle having friction brakes and regenerative braking capability, the method comprising:
during a first deceleration event from a vehicle speed to stationary at a braking request level, allocating a first fraction of a total braking energy to the friction brakes; and
during a second deceleration event from the vehicle speed to stationary at the braking request level, in response to detection of the friction brakes being wet, allocating a second fraction of the total braking energy, greater than the first fraction, to the friction brakes.

14. The method of claim 13 further comprising, during a third deceleration event from the vehicle speed to stationary at the braking request level, in response to dissipation of a predetermined quantity of heat in the friction brakes after the detection, allocating the first fraction of the total braking energy to the friction brakes.

15. The method of claim 13 wherein:
during the first deceleration event, regenerative braking is used at all speeds greater than a first vehicle speed threshold; and
during the second deceleration event, no regenerative braking is used at speeds less than a second vehicle speed threshold greater than the first vehicle speed threshold.

16. The method of claim 13 wherein:
during the first deceleration event, a first maximum fraction of braking force is allocated to regenerative braking; and
during the second deceleration event, a second maximum fraction of braking force less than the first maximum fraction is allocated to regenerative braking.

17. The method of claim 16 wherein the first maximum fraction is 100 percent.
